(19) United States
(12) Patent Application Publication
(10) Pub. No.: US 2006/0100904 A1
(43) Pub. Date: May 11, 2006

(54) System for providing rank information of medical service satisfaction and method thereof

(76) Inventors: Kyoung-Yong Jee, Daejon (KR); Mu-Ho Lee, Gyeonggi-do (KR); Joong-Gul Ko, Seoul (KR); Ji-Woo Seo, Seoul (KR); Taek-Sik Kim, Seoul (KR)

Correspondence Address: LADAS & PARRY LLP, 224 SOUTH MICHIGAN AVENUE, SUITE 1600, CHICAGO, IL, 60604, US

(21) Appl. No.: 11/249,870

(22) Filed: Oct. 13, 2005

(30) Foreign Application Priority Data
Nov. 10, 2004 (KR) 10-2004-0091584

(51) Int. Cl. G06Q 10/00

(52) U.S. Cl. 705/2; 705/11

(57) ABSTRACT

Provided is a medical service satisfaction rank information providing system that computes and provides quantified statistical rank information according to a medical institution/department/doctor upon a user request based on medical service satisfaction points inputted by a user that received a medical service and recommendation points for each medical institution/department/doctor inputted by a service information provider, and a method thereof. The method for providing medical service satisfaction information includes the steps of: a) receiving a medical service satisfaction point and storing the medical service satisfaction point; b) receiving a recommendation point and storing the recommendation point; and c) computing rank information by using the medical service satisfaction point and the recommendation point, and providing the rank information to the user terminal.

### FIELD OF THE INVENTION

The present invention relates to a system for providing rank information of medical service satisfaction; and, more particularly, to a medical service satisfaction rank information providing system that computes and provides quantified statistical rank information according to a medical institution/department/doctor upon a user request based on medical service satisfaction points inputted by a user that received a medical service and recommendation points for each medical institution/department/doctor inputted by a service information provider, and a method thereof.

### DESCRIPTION OF RELATED ART

Generally, medical information includes basic disease information, general introduction of a medical institution, and/or information on medical departments in service, but it does not provide the degree of satisfaction of those who used the medical institution, the degree of satisfaction on doctors of the medical institution, and advantages and disadvantages of the medical institution in detail.

Since it is not possible to acquire medical information desired by medical service users desire in a conventional medical information providing method that collects, searches, and/or compares medical information atypical according to each medical institution, the medical service customers should search and collect limited information only from web sites of many medical institutions, what is talked among people, experience, and/or advertisement.

Also, since the laboriously acquired information does not have a valuation basis for comparison, it is very difficult for the medical service customers to acquire information on medical institution and doctor appropriate for themselves. Therefore, the medical service customers have many difficulties to find a medical institution and a doctor that fit to their diseases.

When a victim of piles wants to receive treatment in a medical institution, the patient does not know detailed information, such as information on doctors of each medical department, differences among doctors in treatment process, and the extent of explanation on a disease except hospital information. Therefore, individuals are deprived of a right to select a medical institution and a doctor due to lack of information.

Generally, selecting a medical institution depends on name-recognition, what is talked among neighbors or an experience, and there are few people who select a medical institution in consideration of doctor information of a medical department or satisfaction of patients.

Therefore, it is required to provide advance information, which allows the medical service consumers to share inforamtion such as advantages and disadvantages in treatment process, and select a medical institution, and a doctor of medical department that fits to a disease and an inclination of a patient by sharing satisfaction with respect to a doctor in charge and feedback comments with each other.

### SUMMARY OF THE INVENTION

It is, therefore, an object of the present invention to provide a medical service satisfaction rank information providing system that computes and provides quantified statistical rank information according to a medical institution/department/doctor upon a user request based on medical service satisfaction points inputted by a user that received a medical service and recommendation points of each medical institution/department/doctor inputted by a service provider, and a method thereof.

Other objects and advantages of the present invention will be understood by the following description and become more apparent from the embodiments in accordance with the present invention, which is set forth hereinafter. It will be also apparent that objects and advantages of the invention can be embodied easily by the means defined in the claims.

In accordance with an aspect of the present invention, there is provided a method for providing medical service satisfaction rank information, including the steps of: a) receiving a medical service satisfaction point individually from terminals of users who received a medical service through a network and storing the medical service satisfaction point in a storing means; b) receiving a recommendation point for each medical institution, medical doctor, and medical department from a medical service information provider and storing the recommendation point in the storing means; and c) computing rank information according to each medical institution, medical department, and medical doctor by using the medical service satisfaction point and the recommendation point for the medical institution/department/doctor stored in the storing means, and providing the rank information to the user terminal upon a request from a user terminal.

The medical service satisfaction information providing method further includes the steps of: performing a member authentication process by using member information stored in the storing means upon access of the user terminal; and receiving feedback comments with respect to a medical institution/treatment from the individual user terminal and storing the feedback comments in the storing means.

In accordance with another aspect of the present invention, there is provided a system for providing medical service satisfaction rank information, including; a satisfaction rank information providing block for individually receiving a medical service satisfaction point from terminals of users who received a medical service, storing the satisfaction point in the storing block, computing medical service satisfaction rank information by using the medical service satisfaction point and a recommendation point of a medical institution/doctor/department stored in the storing block upon a request of a user terminal, and providing the medical service satisfaction rank information to the user terminal; and a storing block for storing member information, medical institution information, treatment information, medical doctor information, a medical service satisfaction point, and a recommendation point for each medical institution/doctor/department.

The present invention suggests satisfaction opinion with respect to many medical institutions, medical departments, and treatment methods of doctors registered by individuals with an experience of medical treatment in a medical institution, and simultaneously provides a method for arranging quantified and statistical satisfaction with respect to a medical institution and a medical doctor in a row, a method that a patient writes feedback comments after receiving medical treatment, and satisfaction rank information of a medical institution and a medical doctor for each disease to people who will receive treatment in a medical institution.

Also, the present invention enables medical service customers evaluate and compare recommendation points and satisfaction information between medical institutions and medical department doctors, and search a medical institution and a doctor that fit to them. The method makes it easy and for the medical service customer to search detailed information based on diverse classification method possible. Also, the medical service customers can be recommended desirable medical institutions, doctors, and medical information.

That is, the present invention allows medical service medical service customers to compare and search medical information of medical institutions according to a medical department, and provides information to those who need satisfaction rank information of the medical institution and the doctor of each medical department by extracting medical institutions and medical doctor information, which are needed by a user, and referring to feedback comments.

Also, the present invention provides information which is helpful for a patient to select a desirable medical institution and doctor by allowing patients to compare and evaluate treatment of a medical institution, a medical department and a doctor, decide a rank by quantizing evaluated values, and record feedback comments.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a medical service satisfaction rank information providing system in accordance with an embodiment of the present invention;

FIG. 2 is a block diagram showing a medical service satisfaction rank information providing method in accordance with an embodiment of the present invention;

FIG. 3 is a flowchart describing a medical service satisfaction point input method through member authentication in accordance with an embodiment of the present invention;

FIG. 4 is a flowchart illustrating a statistical data providing method related to medical service satisfaction in accordance with an embodiment of the present invention; and

FIG. 5 is a block diagram showing a medical service satisfaction information input process and a rank information search process in accordance with an embodiment of the present invention.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on the prior art may blur the points of the present invention, the detailed description will not be provided herein. The preferred embodiments of the present invention will be described in detail hereinafter with reference to the attached drawings.

FIG. 1 is a block diagram showing a medical service satisfaction rank information providing system in accordance with an embodiment of the present invention.

As shown in FIG. 1, the medical service satisfaction rank information providing system includes a medical service satisfaction rank information providing block 121 and storing blocks 122, 123, and 124. Herein, the medical service satisfaction rank information providing block 121 individually receives a medical service satisfaction point from a terminal of users that received a medical service, and stores the point in the storing blocks. Subsequently, the medical service satisfaction rank information providing block 121 outputs medical service satisfaction rank information by using the medical service satisfaction point stored in the storing blocks and the recommendation point of the medical institution/department/doctor, and provides the information to the user terminal.

Meanwhile, the storing blocks store member information, medical institution information, treatment information, doctor information, medical service satisfaction point and medical institution/doctor/department recommendation points. According to the stored information, a storing block becomes a member information database (DB) 122, a hospital information DB 124 and a rank setup information DB 123.

The member information DB 122 provides member information including a medical institution visiting number of a member, a medical department, a doctor in charge. The hospital information DB 124 stores general information of a medical institution and a doctor. The rank setup information DB 123 stores medical service satisfaction evaluation points and feedback comments inputted by users, and recommendation points of each medical institution/department/doctor inputted by a medical service information provider.

A medical service satisfaction rank information providing system 120 stores general information on a medical institution such as history and location, a department of the medical institution, a doctor career in detail in a DB.

That is, if a user terminal 100, which is a client, accesses trough the Internet 110, the medical service satisfaction rank information providing system 120, which is a server, provides services such as rank information, satisfaction, and feedback comments together with the information of a medical institution, a medical department and a doctor to the user terminal 100.

The user terminal 100, which is a client, accesses to the medical service satisfaction rank information providing system 120, which is a server, through the Internet, thereby receiving diverse information and services that a user wants. The user terminal 100 includes a personal computer (PC) or a Personal Digital Assistant (PDA) which is set up at home or office.

The user terminal 100 should access to the medical service satisfaction rank information providing system 120 in a condition of accessing to the Internet 100 in order to receive user satisfaction and rank information of each medical department.

If the user terminal 100 accesses to the medical service satisfaction rank information providing system 120, a web site provides a service selection menu and a log-in screen as well as introduction and diverse services guidance.

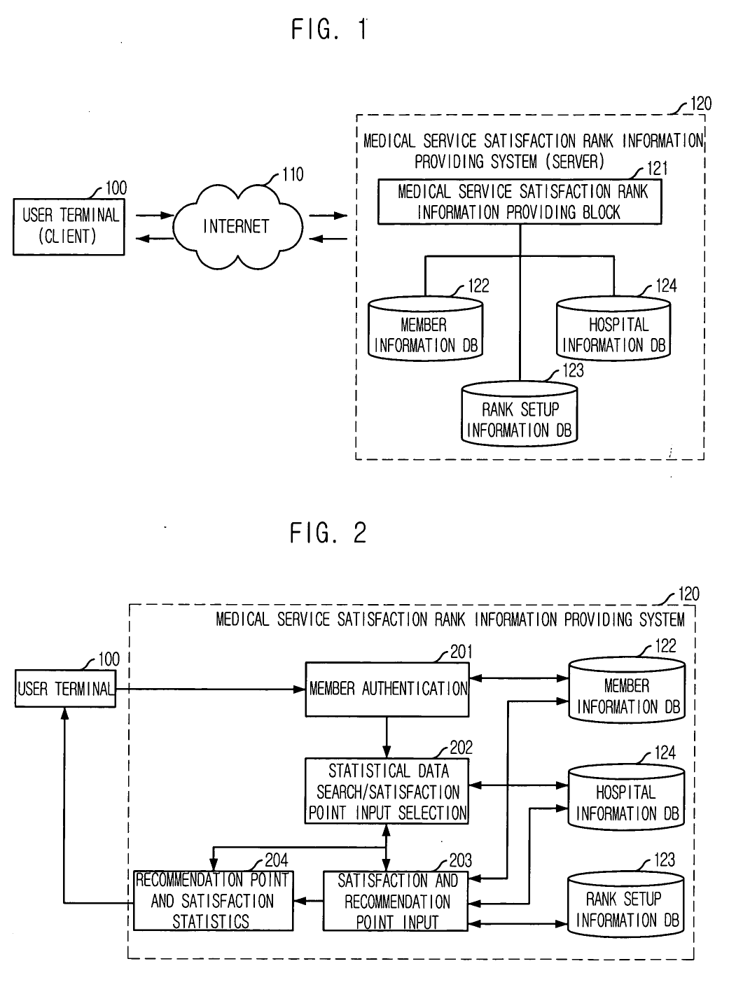

FIG. 2 is a block diagram showing a medical service satisfaction rank information providing method in accordance with an embodiment of the present invention, and a general diagram showing a function and rank information of each database in a medical service satisfaction rank information providing system.

If the user 100 accesses to the medical service satisfaction rank information providing system 120, which is a web server, more particularly, to the medical service satisfaction rank information providing block 121, through Internet, the medical service satisfaction rank information providing block 121 performs a member authentication process checking whether the user is a member or not (see 201).

It is determined by member information stored in the member information DB 122 in the member authentication process whether the user is a member or not (see 201). Personal information, an evaluation number and an access number are stored in the member information DB 122 when a user subscribes as a new member.

Meanwhile, in a statistical data search/satisfaction point input selection process (see 202), a user can select a process for requesting search of statistical data such as rank information or a process for inputting satisfaction. Searching medical institution introduction, location of a medical institution, a medical department, consultation hours, and doctor information, which are stored in the hospital information DB 124, is also possible. Medical department information, reservation condition of sick rooms, profile of a medical doctor, the number of people on a waiting list as well as general information such as location and history of the medical institution are stored in the hospital information DB.

The medical service satisfaction rank information providing block 121 receives a satisfaction evaluation point with respect to a medical service from a user and registers the point (see 203). The medical service satisfaction rank information providing block 121 can also search statistical data such as a recommendation point and satisfaction rank information of a medical institution/doctor/department, and provide the statistical data to the user (see 204). As described above, the medical service information provider can input the recommendation point, which is objective evaluation data on a medical institution/doctor/department, and store the recommendation point in the rank setup information DB 123 (see 204). Herein, the recommendation point for the medical institution/doctor/department is a point previously evaluated and stored by a medical service information provider, The recommendation point of the medical institution is an objective evaluation point computed in consideration of facility, size, medical equipment, the number of doctors in the medical institution. The recommendation point of school, career, research achievement, the number of patients, and a cure rate of a doctor. The recommendation point for a medical department is an objective evaluation point computed in consideration of the number of doctors per department, subdivision extent of each department, the number of patients per department.

To be specific, in the satisfaction and recommendation point input process (see 203), a member that received treatment in a medical institution can input feedback comments, a satisfaction point, and a recommendation point with respect to the medical institution and doctors. The statistical process information of the inputted information can be provided as useful information in selecting a medical institution and a doctor. The information is provided only to users with membership, and made by integrating the member information DB 122, the hospital information DB 124 and the rank setup information DB 123. Herein, the rank setup information DB 123 stores a recommendation point individually inputted according to a medical institution/doctor/department, a satisfaction evaluation point and feedback comments inputted by users.

When a user selects a medical department that the user wants to know more, and requests rank data, the medical service satisfaction rank information providing block 121 activates the rank setup information DB 123 and outputs the rank data according to a medical institution, a department, and a doctor.

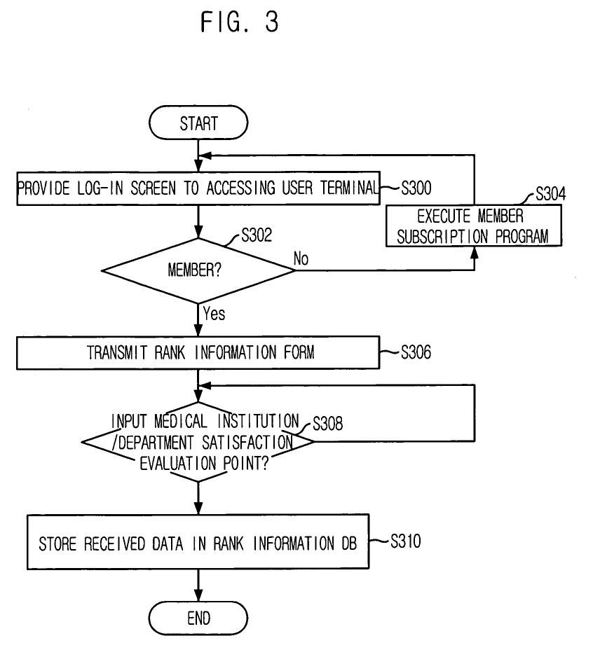

FIG. 3 is a flowchart describing a medical service satisfaction point input method through member authentication in accordance with an embodiment of the present invention.

If the user terminal 100 accesses to the medical service satisfaction rank information providing block 121 through the Internet, the medical service satisfaction rank information providing block 121 introduces a web site, guides the user into diverse services, and provides a service selection menu and a log-in screen to the user terminal at step S300.

At step S302, it is determined upon the log-in of the user whether the user is a member or not. If the user is not a member, a member subscription program is executed and a member subscription process is performed at step S304. Subsequently the logic flow goes again to the step S300. Member personal information inputted to the member subscription procedure is stored in the member information DB 122, and the member receives an identification (ID). Then, the user can use the service by accessing to the web site, i.e., the medical service satisfaction rank information providing system, with the ID later.

There is a difference between a web site provided to a user with membership and a web site provided to a user without membership. If a user does not log in as a member, the user can only search a medical institution, a satisfaction rank, and a recommendation point. If the user wants to input a satisfaction point of each medical institution/doctor/department, the user should sign in as a member in the web site.

Meanwhile, when a member inputs satisfaction and rank information with respect to a medical institution and doctor, the member should obtain a rank information form. If there is an application of the member, i.e., if rank information and satisfaction data input service are selected, the medical service satisfaction rank information providing block 121 transmits the rank information form to the user terminal at step S306. Herein, the rank information form includes treatment data, the name of medical department, the name of a medical doctor, and the name of a medical institution.

Subsequently, if satisfaction evaluation points for a medical institution and a doctor, which is a satisfaction point with respect to a medical institution and a doctor treating a user, are inputted, i.e., if satisfaction points per rank information form detail are inputted, the inputted data are stored in the rank setup information data 123 at step S310. Also, if a user has ant recommendation, the user clearly writes what is recommended. Also, in feedback comments board, the user can write his/her subjective feeling after receiving treatment and freely write details such as feeling of treatment, a service, good points and bad points. The described contents are stored as details in the rank setup information DB.

A user with membership can input a satisfaction point or feedback comments, but a user without membership user can only search information within a limited range.

It is not possible to give an evaluation point or a satisfaction point to the same medical institution or doctor more than twice in order to prevent unfair activity that arbitrarily inputs a biased point to a certain doctor or medical institution. However, it is possible to give an evaluation point to the same medical institution or doctor when the user receives treatment consistently in the same medical institution with one ID every 15 days.

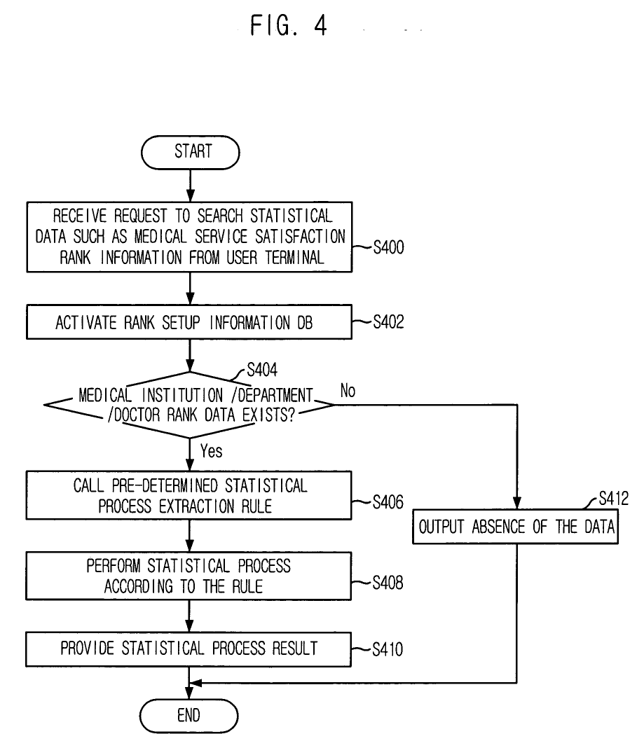

FIG. 4 is a flowchart illustrating a statistical data providing method related to medical service satisfaction in accordance with an embodiment of the present invention.

At step S400, if a user accesses to the medical service satisfaction rank information providing block 121 and requests to search statistical data such as medical service satisfaction rank information, the medical service satisfaction rank information providing block 121 activates the rank setup information DB 123 at step S402. Herein, the satisfaction points and feedback comments with respect to a medical institution and a doctor, which are stored by members receiving treatment in the medical institution, are stored in the rank setup information DB 123.

At step S404, it is checked whether rank data with respect to a medical department, a medical institution, and a medical doctor in data that the user requests exist in the rank setup information DB 123. If the data do not exist, a pre-determined statistical process extraction rule is called at step S406. Otherwise, it is outputted at step S412 that the information do not exist.

At step S408, the hospital information DB 124, the member information DB 122, and the rank setup information DB 123 are integrated, thereby statistically processing details of the medical institution, a recommendation point for medical institution/doctor/department, and gender distinction, age and region of an individual attending the satisfaction point as well as the medical institution and doctor satisfaction rank. Herein, the medical service satisfaction rank is found by comparing values that add medical service satisfaction point, i.e., a satisfaction point with respect to the medical institution/doctor/department, inputted by a member and a recommendation point of the medical institution/doctor/department inputted by a medical service information provider according to the medical institution/doctor/department.

At step S410, the statistically processed result is provided to the user terminal 100. The statistically processed result includes a satisfaction rank of a medical institution and doctor with respect to the disease requested by the user, and more particularly, it includes a statistical process result with respect to age, gender distinction, job of a participant of satisfaction evaluation as well as detailed information of the medical institution shown in the rank such as a medical institution outline, a medical department, doctors, patient reservation condition, average waiting time, an available treatment date.

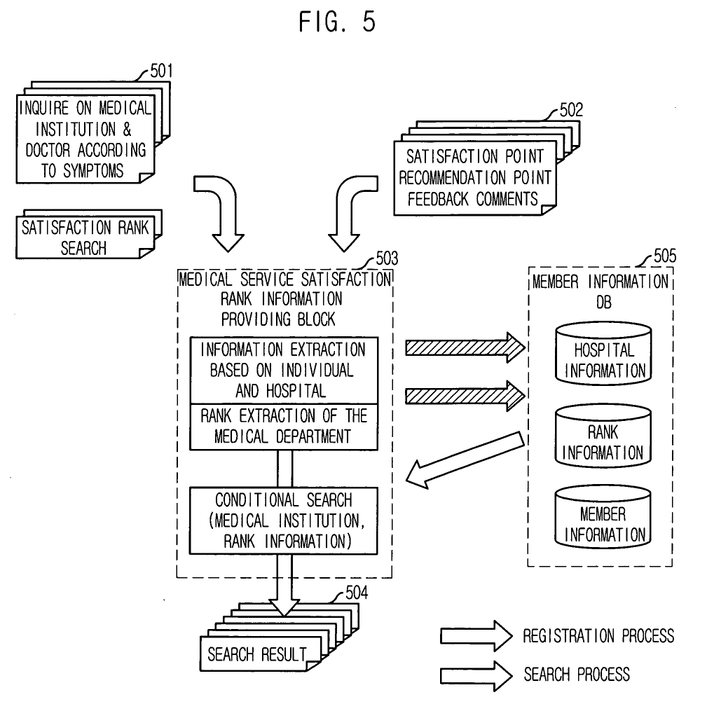

FIG. 5 is a block diagram showing a medical service satisfaction information input process and a rank information search process in accordance with an embodiment of the present invention.

As shown in FIG. 5, at step S501, the medical service satisfaction rank information providing system simultaneously performs an input process and a search process, and can request to search a medical institution, a satisfaction rank, and information according to symptoms. At step S502, a member can search information and input a satisfaction point and feedback comments. Also, the recommendation point can be inputted. The recommendation point is information that a medical service information provider stores as a recommendation point with respect to a medical institution/doctor/department.

At step S504, when there is a user request in case of a search process, conditional search is performed by extracting personal information of a member and rank information of a medical institution in a process module C, and a search result is outputted.

Meanwhile, satisfaction and feedback comments with respect to a medical institution and a medical doctor, which are written by a member, are stored in the rank information DB 505, and they are converted into points based on a statistical algorithm. If the member inputs a point based on a predetermined standard, the conversion is unnecessary. Subsequently, the point is stored in the rank setup information DB, and becomes a basis for providing rank information, i.e., basic data.

The DB 505 based on the basic data finally goes through a statistical process, and shows points obtained by adding inputted by accumulated recommendation point and an accumulated satisfaction point inputted by medical institution users on a screen. The screen is provided to all users including those without membership, and they can obtain desired information from the screen.

A search process is available to those without membership, but a registration process is available only to a member.

As shown in FIG. 5, if a user inquires on a disease or a medical institution (see 501), a medical service satisfaction rank information providing block 503, which is a process module, provides information 504 meeting conditions by extracting information in a hospital information DB, a rank setup information DB, and a member information DB 505. Meanwhile, satisfaction evaluation point 502 inputted by a user is stored in the DB 505 through the medical service satisfaction rank information providing block 503, which is a process module.

As described in detail, the method of the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

The present invention is not for judging the quality of a medical institution and a doctor, but for obtaining information when a patient suffering from a disease selects a medical institution and a doctor.

Since the present invention also provides medical institution and doctor satisfaction rank information according to a disease, the medical institution can know medical institution preference and complaints of patients and use the information as aggressive marketing data. Also, the patients using the medical institution can improve convenience of the medical institution, and increase satisfaction with respect to the medical institution by selecting a desirable doctor or medical institution that fits to the disease of the patient.

The present application contains subject matter related to Korean patent application No. 2004-0091584, filed with the Korean Intellectual Property Office on Nov. 10, 2004, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A method for providing medical service satisfaction rank information, comprising the steps of:
a) receiving a medical service satisfaction point individually from terminals of users who received a medical service through a network and storing the medical service satisfaction point in a storing means;
b) receiving a recommendation point for each medical institution, medical doctor, and medical department from a medical service information provider and storing the recommendation point in the storing means; and
c) computing rank information according to each medical institution, medical department, and medical doctor by using the medical service satisfaction point and the recommendation point for the medical institution/department/doctor stored in the storing means, and providing the rank information to the user terminal upon a request from a user terminal.

2. The method as recited in claim 1, further comprising the step of:
d) performing a member authentication process by using member information stored in the storing means upon access of the user terminal.

3. The method as recited in claim 2, wherein only members authenticated in the step d) can input the medical service satisfaction point in the step a).

4. The method as recited in claim 3, wherein the medical service satisfaction point can be inputted only once during a pre-determined period with one user identification information in the step a).

5. The method as recited in claim 4, wherein the step a) further includes the step of:
a1) receiving feedback comments with respect to a medical institution/treatment from the individual user terminal and storing the feedback comments in the storing means.

6. The method as recited in claim 5, wherein detailed information including a medical institution, a medical department, a medical doctor, a patient reservation condition, an average waiting time, and an available treatment date is provided together with the rank information upon the user request in the step c).

7. A system for providing medical service satisfaction rank information, comprising:
a satisfaction rank information providing means for individually receiving a medical service satisfaction point from terminals of users who received a medical service, storing the satisfaction point in the storing means, computing medical service satisfaction rank information by using the medical service satisfaction point and a recommendation point of a medical institution/doctor/department stored in the storing means upon a request of a user terminal, and providing the medical service satisfaction rank information to the user terminal; and
a storing means for storing member information, medical institution information, treatment information, medical doctor information, a medical service satisfaction point, and a recommendation point for each medical institution/doctor/department.

8. The system as recited in claim 7, wherein the satisfaction rank information providing means includes:
a means for receiving a medical service satisfaction point individually from terminals of users who received a medical service through a network and storing the medical service satisfaction point in a storing means;
a means for receiving a recommendation point for each medical institution, medical doctor, and medical department from a medical service information provider and storing the recommendation point in the storing means; and
a means for computing rank information according to each medical institution, medical department, and medical doctor by using the medical service satisfaction point and the recommendation point for the medical institution/department/doctor stored in the storing means, and providing the rank information to the user terminal upon a request from a user terminal.
